(19) United States
(12) Patent Application Publication
(10) Pub. No.: US 2006/0212373 A1
(43) Pub. Date: Sep. 21, 2006

(54) Method of providing financial accounting compliance

(75) Inventors: Catherine H. Maxwell, Pearland, TX (US); Randy Gene Kruger JR., Crosby, TX (US); Andrew P. Broussard, Kingwood, TX (US)

Correspondence Address: CALPINE;C/O POWER SYSTEMS MFG. LLC, 1440 WEST INDIANTOWN ROAD, SUITE 200, JUPITER, FL, 33458, US

(73) Assignee: CALPINE ENERGY SERVICES, L.P.

(21) Appl. No.: 11/081,221

(22) Filed: Mar. 15, 2005

(51) Int. Cl. G06Q 40/00

(52) U.S. Cl. 705/35

(57) ABSTRACT

The present invention discloses a method of establishing an internal control framework that ensures accurate financial reporting as required by the Sarbanes-Oxlet Act of 2002. The method provided utilizes the established business processes to identify risks, determine the necessary controls to be implemented to mitigate these risks in order to ensure that financial assertions, and as a result, accounts, are accurate. Following this process thereby reduces costs associated with audits and compliance with the new accounting rules when compared to other publicly known methods of compliance.

### TECHNICAL FIELD

The present invention relates generally to financial reporting and more specifically to a method of establishing an internal control framework to ensure compliance with external accounting guidelines.

### BACKGROUND OF THE INVENTION

Financial accounting has always been a cornerstone of any business regardless of the business size and corresponding revenue. In general the accounting of any business records includes costs of producing a product or service, the sale of a good or service, and the corresponding profit or loss due to the sale of that good or service. While simple in theory, financial accounting becomes extremely complex as the business grows in size and corresponding transactions or sales. If extreme care and diligence is not taken, errors or mistakes can occur directly affecting the business finances. For publicly traded companies, accurate accounting is even more important since investors exchange their monies for shares of stock, or partial ownership, in the company.

The issue of financial accounting of publicly traded companies became of critical importance in 2001 and 2002 with revelation of major corporate and accounting scandals involving a number of prominent corporations in the United States. A number of these scandals involved the misstatement of corporate earnings to further bolster the corporate stock price or corporate leadership embezzling money from the company. This problem was not only at the corporate level, but also involved the independent accounting firms that companies used to verify and certify their corporate financial statements. As a result, the stock price of these publicly traded companies was inflated and when financial statements were corrected, the stock prices collapsed and investor confidence in these companies fell leading many to seek bankruptcy protection and costing thousands of people their jobs and drastically affecting investors retirement and investment portfolios. Furthermore, for other companies in similar businesses to those that mislead investors, their stock price as well as their respective investor confidence levels was also negatively affected.

In response to these accounting scandals, the United States Congress enacted the most extensive reform to the United States financial markets since the Securities Act of 1934. Entitled The Public Company Accounting Reform and Investor Protection Act of 2002, or more commonly known as the Sarbanes-Oxley Act for its principal architects, this Act was enacted to restore confidence in the accounting procedures used by publicly traded companies. There are numerous sections to this Act, but the most challenging section of this Act for a publicly traded company to comply with is generally agreed to be Section 404, entitled Management Assessment of Internal Controls, which requires most publicly registered companies and their external auditors to report on the company's internal control over financial reporting.

Under this new law, companies have a limited time to comply with these new regulations and there is an inherent cost, in time and money, to each company in order to establish the internal framework that complies with the new regulations as well as to have it verified by independent auditors. Therefore, it is imperative that while a company complies with these regulations, it is in their best interest to do so in the most efficient manner possible, so as to save labor time and financial resources.

As part of the Sarbanes-Oxley Act of 2002, the law established the Public Company Accounting Oversight Board (PCAOB) whose purpose is to oversee the auditors of public companies. Their oversight of the auditors is intended to better protect the interests of investors with respect to the preparation of corporate audit reports. In order to aid companies in establishing controls that comply with Section 404 of the Sarbanes-Oxley Act, the PCAOB has provided companies with a rough framework that when implemented will help a company to establish the necessary internal controls to ensure accurate financial reporting. While this framework, when implemented, can result in a process that complies with the new accounting guidelines, the process identified by the PCAOB views the company financials from an auditors perspective. That is, the process is one that an auditor would undergo to verify that controls are in place to ensure accurate financial reporting, which is not necessarily the most efficient process to identify what controls are necessary to achieve this result.

While the PCAOB process for complying with Section 404 of the Sarbanes-Oxley Act is publicly available, it will be explained briefly. This procedure begins from the financial accounts perspective by identifying significant accounts from company financial statements. A significant account is generally defined as one in which there is a more than remote likelihood that the account could contain misstatements that either individually or with others could materially effect the overall financial statements. Once the significant accounts have been identified, assertions made from those accounts are identified. Assertions made are classified into the following categories: existence or occurrence, completeness, rights and obligations, valuation or allocation, presentation and disclosure, and prevention of fraud. An example of an assertion made in a significant account is that all transaction made during a specified period are in fact recorded. Once the assertions have been identified, the next step in the PCAOB process is to identify significant processes that affect the significant accounts. An example of these processes is a sales transaction that generates revenue to a significant account. Next, the auditor would identify the risks that are inherent in the significant processes. Types of risks include, but are not limited to, information processing risk, estimating risks, financial reporting risks, and system risks. An example risk of the information processing type would be inaccurate data capture of sales. Having identified the accounts, assertions, processes, and risks, the auditor can then identify controls that should be implemented to ensure accurate financial reporting. However, by following this process, and essentially working from the financial accounts backwards to the process that generate the accounts, often times the controls identified require the processes to change. Changing the way in which a company does business (i.e. processes) can be a very costly adjustment for companies and require extensive time to implement. Furthermore, it is more efficient to identify the controls necessary earlier in the transaction than to implement controls later. Finally, in any transaction, the risk is a function of the process and therefore embedded in the process, not the accounts. Therefore, the risks must be known first in order to accurately identify the assertions, thus preventing unnecessary iterations in creating a control framework.

What is needed is an alternate method of complying with the financial reporting requirements of Section 404 of the Sarbanes-Oxley Act that reduces the cost of implementing Sarbanes-Oxley compliance while minimizing the impact on existing business processes.

### SUMMARY AND OBJECTS OF THE INVENTION

A method of establishing an internal control framework that ensures accurate financial reporting is disclosed. The method provided utilizes the established business processes to determine the necessary controls to be implemented in order to ensure that financial assertions and accounts are accurate. By following this process of working from established business processes to financial accounts, as opposed to working from financial accounts and assertions and following these accounts to their respective business processes, no business processes have to be modified or changed, and costs associated with audits and compliance with the newly enacted accounting rules are reduced.

It is an object of the present invention to provide a financial accounting process that results in accurate financial reporting for all accounts with minimal changes to current business processes.

In accordance with this and other objects, which will become apparent hereinafter, the instant invention will now be described with particular reference to the accompanying drawings.

### BRIEF DESCRIPTION OF THE DRAWINGS

FIG. 1 is a diagram outlining the general steps related to a business transaction with respect to financial accounting as outlined by the preferred embodiment of the present invention.

FIG. 2 discloses an example of a business transaction in accordance with the preferred embodiment of the present invention.

### DETAILED DESCRIPTION OF THE PREFERRED EMBODIMENT

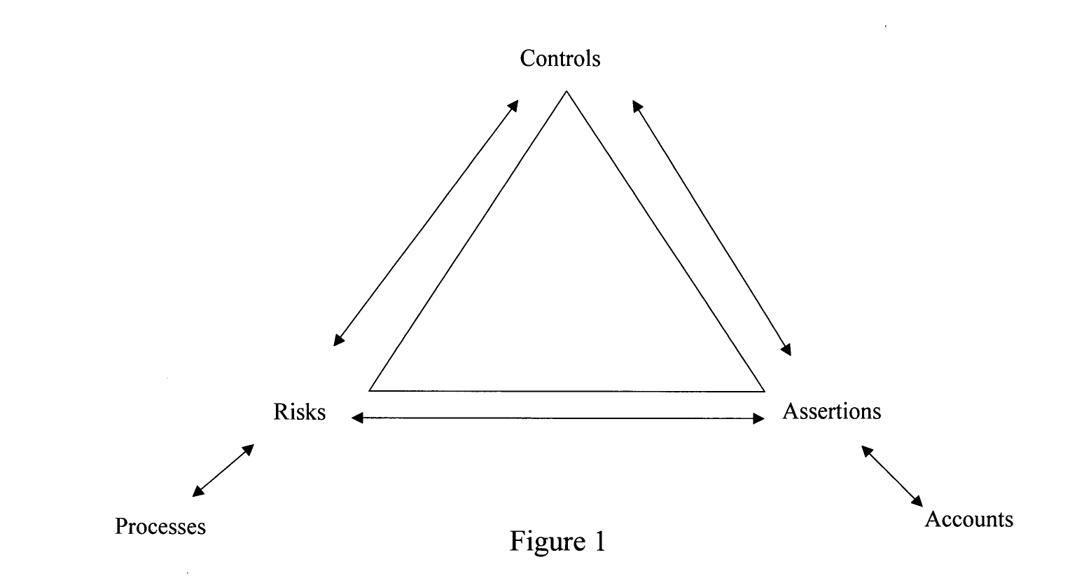

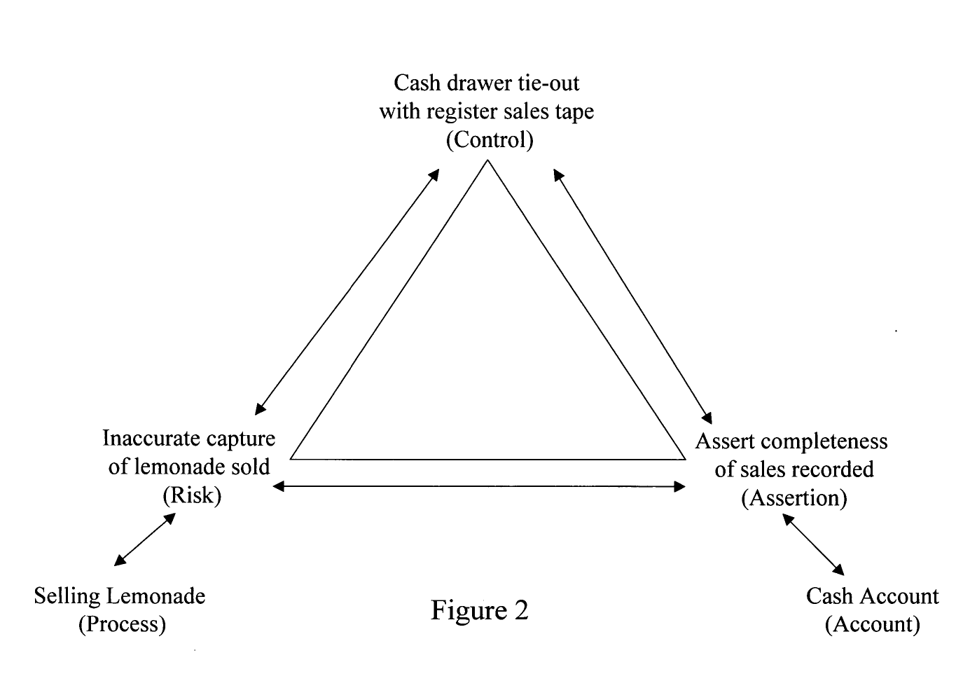

The present invention will now be described in greater detail with the respect to the accompanying drawings shown in FIGS. 1 and 2. A method of establishing an internal control framework that ensures accurate financial reporting is disclosed. While this internal control framework can be established in a number of manners, the inventors of the present invention have established a method for complying with Sarbanes-Oxley which follows the inherent linkages of processes to risks, risks to controls and assertions, and assertions to accounts, thereby reducing the costs associated with adopting and maintaining compliance.

The method of establishing an internal control framework that ensures accurate financial reporting for a business with respect to external accounting guidelines comprises the steps of first identifying all processes of the business. The processes of the business can vary, but are intended to include all various transactions that would materially impact a business financial account. Next, the risks are identified, assessed, and linked to all processes of the business. For the preferred embodiment of the present invention, risk types comprise information processing, estimates, fraud, errors, and financial reporting. Depending on the number of transactions occurring and the type of transactions, risks can be ranked based on the likelihood of occurrence and their significance. Once the risks have been identified, controls that mitigate these risks are identified and each control is linked to its respective risk. Depending on the type of risk, multiple controls may be necessary to fully mitigate the risk. Next, the financial assertions made by the business are identified and the risks and controls pertaining to the respective financial assertion are linked together. Finally, business financial accounts are identified and the assertions are linked to their respective financial accounts such that each of the processes first identified is linked to a financial account. In order to ensure that all processes are linked to financial accounts, it is common for internal and external analysis of the resulting internal control framework to be conducted to identify any gaps that require remediation.

The internal control framework established by the present invention can apply to a variety of businesses and processes ranging from the extremely complex having hundreds of thousands of transactions, to a very basic business containing few processes. This methodology was initially developed for a company specializing in energy marketing and sales that involves hundreds of thousands of transactions in a given fiscal year. However, since this method can apply to a variety of businesses from the very complex, such as energy marketing and sales, to a very basic case, the present invention will best be understood if the steps outlined are explained with respect to a very basic case study. For this basic case study, a number of simplified businesses can be used to model the methodology, however a cash-based lemonade stand will be used to explain how to ensure the financial accounts for the stand are accurate.

In this case study, which is shown pictorially in FIG. 2, the internal control framework that ensures accurate financial reporting for a cash account of a lemonade stand will be described in detail. For a basic business such as a lemonade stand, which for this example is a cash account business, one of the processes to identify and understand is the sale of lemonade. Next, a risk identified and associated with the process of selling lemonade is the accuracy of sales, and more specifically the inaccurate capture of lemonade sold. Inaccurate or incomplete records of sales can lead to reduced earnings and loss of inventory of lemonade and other supplies. Understanding the risk of inaccurate capture of lemonade sold, it is necessary to identify a control or controls that can be implemented to mitigate this risk. One such control to implement is a cash drawer tie-out with the register sales tape, such that the cash in the register matches the register tape that is used to record lemonade sales. Linking these two elements of the transaction together ensures that all of the lemonade sales are accounted for from a cash standpoint. A financial assertion made by the lemonade stand business with respect to the process of selling lemonade would be that the sales records for lemonade are complete. If this assertion is inaccurate, it can result in inaccurate financial reporting of business sales. Both the risks and controls are linked to this assertion directly. Inaccurate capture of lemonade sold causes the sales record to be incomplete. However, by way of the control implemented, completeness of sales recorded is ensured by way of tying the cash drawer to the register sales tape for all lemonade sales. Therefore, FIG. 2 shows that if the control is not implemented then the risk can directly affect the assertion. Once the assertion has been made, and it is known how the assertion is linked to the control and risk, it is therefore linked indirectly to the process. The account identified in this case study, and linked to the assertion of complete sales records, is a cash account. This methodology shows how the process of selling lemonade is linked to the cash account. Therefore, it is known for financial reporting and auditing of the accounts, which processes have an impact on the account and what steps must be taken in order to ensure the accuracy of the account.

It is important to note that depending on the business and associated processes, more than one control may apply to a specific process in order to ensure accurate financial accounting. Depending on the nature of processes involved often times a matrix of required controls is preferred to show the links between multiple controls and their associated risks as well as to prioritize the controls.

The advantages of following the method identified herein are numerous including primarily the reduction in costs associated with complying with Section 404 of the Sarbanes-Oxley Act of 2002. Also, as it can be seen from the case study example provided, the methodology identified herein follows the business process in a more fluid manner than the PCAOB steps, which begins with the financial accounts of a business. By following the natural progression of a transaction, controls are identified and implemented earlier in the life of a transaction than with other procedures. Implementing these controls earlier than with the PCAOB methodology reduces the cost and time necessary to comply with the Sarbanes-Oxley Act by mitigating potential financial risks sooner than later. Finally, it can be seen from this basic case study, that this methodology can conform to any number of businesses and transactions, from as simple as a cash sale of lemonade to a complicated transaction such as buying and selling electricity and gas for a power generation company.

As it has been previously discussed, cost of compliance with the Sarbanes-Oxley Act of 2002 is critical since the company pays for the costs associated with compliance through reduced earnings. Therefore it is desirable to lower these costs if at all possible. The assignee of the present invention utilized different methods in their different divisions for complying with the Sarbanes-Oxley Act of 2002. One division followed the PCAOB guidelines as published to ensure their financial accounts complied with the Sarbanes-Oxley Act of 2002, while another division, including the inventors of the present invention, re-examined this procedure and established the methodology described herein. The result was a significant cost savings in preparation, auditing, and documenting costs compared to the methodology previously known. Specifically, for the assignee, a corporation having revenue of nearly $9 billion in 2003, the applicants complied with Sarbanes-Oxley Act of 2002 for a much lower cost. On average, U.S. publicly traded companies having revenue of over $4 billion annually are spending on average $35 million to comply with the rules of Sabanes-Oxley when following the steps outlined by the PCAOB. The inventors of the present methodology spent less than 5% of that amount in order for their business unit to comply with the new rules defined by Sarbanes-Oxley.

While the invention has been described in what is known as presently the preferred embodiment, it is to be understood that the invention is not to be limited to the disclosed embodiment but, on the contrary, is intended to cover various modifications and equivalent arrangements within the scope of the following claims.

What we claim is:

1. A method of establishing an internal control framework that ensures accurate financial reporting for a business with respect to external accounting guidelines, said method comprising the steps:
identifying all processes of said business;
identifying and assessing risks for each of said processes identified and linking said risks to said processes;
identifying controls that mitigate said risks and linking said controls to said risks;
identifying financial assertions made by said business and linking said risks and said controls to said assertions; and,
identifying business financial accounts and linking said assertions to said accounts such that each of said processes for a business is linked to a financial account.

2. The method of claim 1 wherein said processes include various transactions that materially impact said financial accounts.

3. The method of claim 1 wherein said risks comprise information processing, estimates, fraud, errors, and financial reporting.

4. The method of claim 3 wherein said risks are assigned a rank based on the likelihood of occurrence and significance.

5. The method of claim 1 wherein the step of identifying business financial accounts is followed by the step of conducting an analysis of said internal control framework to assess if all of said processes are linked to said financial accounts.
